(19) United States
(12) Patent Application Publication
(10) Pub. No.: US 2012/0252954 A1
(43) Pub. Date: Oct. 4, 2012

(54) METHOD FOR PRODUCING A TWO-DIMENSIONAL RUBBER COVERING AND TWO-DIMENSIONAL RUBBER COVERING

(75) Inventors: Gregor Grun, Weinheim (DE); Mario Kroeger, Bruchsal (DE)

(73) Assignee: NORA SYSTEMS GMBH, Weinheim (DE)

(21) Appl. No.: 13/514,500

(22) PCT Filed: Oct. 25, 2010
(86) PCT No.: PCT/EP2010/006499

§ 371 Date: Jun. 7, 2012

(30) Foreign Application Priority Data
Dec. 22, 2009 (DE) 10 2009 060 440.5

(51) Int. Cl. C08L 25/10; C08K 3/34

(52) U.S. Cl. 524/447; 524/575

(57) ABSTRACT

A method for producing a two-dimensional rubber covering, in particular a floor covering, comprising the following steps: preparing an unvulcanised rubber material, mixing a filler into the unvulcanised rubber material, converting the rubber material into a two-dimensional state, and crosslinking the rubber material in the two-dimensional state. The method includes that the filler contains particles of glass, porcelain, earthenware and/or stoneware. Also, a covering produced in the described manner.

### BACKGROUND OF THE INVENTION

The present invention relates to a method for producing a two-dimensional rubber covering, in particular a floor covering, comprising the following steps:

providing an unvulcanized rubber material, mixing a filler into the unvulcanized rubber material, rendering the rubber material into a two-dimensional state, and crosslinking the rubber material in the two-dimensional state. The invention also relates to a two-dimensional rubber covering.

A method for producing a two-dimensional rubber covering is known from German laid-open document DE 101 56 635 A1. In the prior-art method, a filler is mixed into an unvulcanized rubber material and the mixture thus obtained is calandered in order to render the rubber material into a two-dimensional state. Subsequently, the rubber material is crosslinked.

There is a need for a method for producing two-dimensional rubber coverings that are easy to process. Therefore, the objective of the present invention is to put forward a method of the type described above which permits easy processing.

This objective is achieved with the above-mentioned method in that the filler contains particles of glass, porcelain, earthenware and/or stoneware.

In this manner, the processing properties of the unvulcanized rubber mixture can be markedly improved. In particular, the use of particles of glass, porcelain, earthenware and stoneware allows a simple and effective thorough mixing of the components. This can be due to the fact that, among other things, the viscosity of the mixture is reduced, which facilitates the processing. As a result, the processing times are also shortened and the reliability of the process is increased. At the same time, the above-mentioned substances make it possible to crosslink the rubber material within a short period of time. Moreover, the production costs can be kept low, since the above-mentioned substances not only reduce the quantity of rubber material that has to be used, but also are inexpensively available. Furthermore, the use of particles of glass, porcelain, earthenware and stoneware makes it possible to save on other substances contained in the rubber mixture such as, in particular, crosslinking accelerators or other additives, without this having a detrimental effect on the processing properties or on the processing time. This likewise contributes to a cost reduction since the use of relatively expensive additives is kept low. Last but not least, glass, porcelain, earthenware and stoneware are also characterized in that they are not problematic from an environmental point of view. The method according to the invention particularly allows the production of low-emission coverings. The fillers being proposed make it possible to achieve a high product quality for the coverings, which are especially well-suited as floor coverings. In this process, excellent mechanical characteristic values can be attained such as especially the hardness, rebound resilience, tensile strength, elongation at break, tear propagation resistance, and surface abrasion. This applies to the use of particles of glass as well as to particles of porcelain, earthenware and/or stoneware, which constitute fired ceramic materials.

Good processing properties and a good product quality can especially be attained when the Mooney viscosity of the unvulcanized rubber material is less than 160 ML (1+4) 100° C. as measured according to DIN standard 53523 after the filler has been admixed into it. The above-mentioned Mooney viscosity is determined according to DIN standard 53523. The expression ML (1+4) 100° C. means that the viscosity is measured using a conventional rotor corresponding to the DIN specification, with a preheating time of one minute and a test duration of 4 minutes at a test temperature of 100° C. in the test chamber. Preferably, the Mooney viscosity is less than 145 ML (1+4) 100° C. and especially preferably less than 120 ML (1+4) 100° C.

### SUMMARY OF THE INVENTION

According to the invention, it has proven to be especially conducive if the particles of glass, porcelain, earthenware and/or stoneware are recycled materials. The utilization of these recycled materials reduces the use of resources and lowers energy consumption during production. Here, for example, reusable materials that are obtained as production waste can be employed. On the other hand, it is also possible to use materials from products that have already completed their life cycle such as, for instance, old glass.

Good processing properties and good adhesion of the particles in the rubber material can be achieved if the particles of glass, porcelain, earthenware and/or stoneware are mixed in as a ground-up product. Here, it has proven to be advantageous if the d₅₀ value of a grain size of the particles is between 1 μm and 200 μm, especially between 1 μm and 20 μm. The d₅₀ value is a statistical median value indicating the mean size of the particles. A d₅₀ value of the particles between 1 μm and 15 μm, especially between 10 μm and 12 μm, has proven to be particularly conducive. The ground-up product can be admixed as glass powder, porcelain powder, earthenware powder and/or stoneware powder, or else as a mixture of these.

Advantageously, the particles of glass, porcelain, earthenware and/or stoneware are admixed in a proportion of 10% by weight to 80% by weight, relative to the two-dimensional rubber covering. Consequently, the finished rubber covering contains between 10% by weight and 80% by weight of the particles.

The rubber covering can advantageously be crosslinked with peroxides, sulfur and/or additives. The crosslinking with sulfur can be accelerated by using cross-linking accelerators or combinations thereof. These can especially contain substances belonging to the classes of dithiocarbamates, metal salts of dithiocarbamates, thiurams, mercapto accelerators, sulfenamides and/or guanidines.

The processing and especially the crosslinking can then be further improved if the particles have basic properties. In particular, particles of glass can have basic properties that allow an acceleration of the crosslinking. The crosslinking with sulfur can be accelerated by using particles of glass. This can considerably reduce the use of crosslinking accelerators, without this leading to undesirably long crosslinking times.

According to the invention, it has proven to be advantageous if the rubber material contains SBR (styrene butadiene rubber), NBR (nitrile butadiene rubber), HNBR (hydrogenated nitrile butadiene rubber), EPDM (ethylene propylene diene rubber), EPM (ethylene propylene rubber), EVA (ethylene vinyl acetate), CSM (chlorosulfonyl polyethylene rubber), CR (chloroprene rubber), VSI (silicone rubber) and/or AEM (ethylene acrylate rubber).

Moreover, the invention relates to a two-dimensional rubber covering, particularly for floors. According to the invention, particles of glass, porcelain, earthenware and/or stoneware are admixed into it as fillers.

### BRIEF DESCRIPTION OF THE DRAWINGS

Additional objectives, features, advantages and application possibilities of the present invention can be gleaned from the description below of embodiments with reference to the drawing. In this context, all of the described features, either on their own or in any desired combination, constitute the subject matter of the invention, irrespective of their compilation in the individual claims or in the claims to which they refer back.

FIG. 1 schematically shows a method according to the invention for producing a two-dimensional rubber covering.

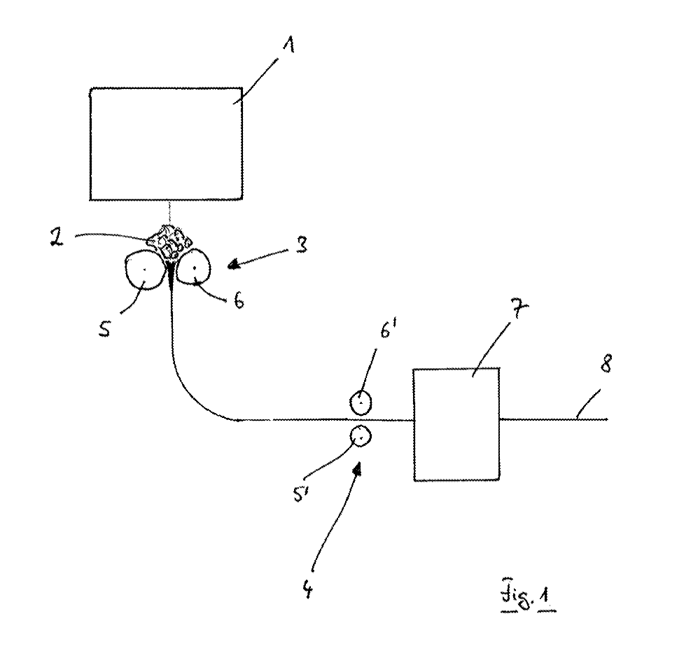

### DESCRIPTION OF THE PREFERRED EMBODIMENTS

With the method, first of all, an unvulcanized rubber material is provided. In particular, this can be SBR (styrene butadiene rubber), NBR (nitrile butadiene rubber), HNBR (hydrogenated nitrile butadiene rubber), EPDM (ethylene propylene diene rubber), EPM (ethylene propylene rubber), EVA (ethylene vinyl acetate), CSM (chlorosulfonyl polyethylene rubber), CR (chloroprene rubber), VSI (silicone rubber) and/or AEM (ethylene acrylate rubber) or a mixture thereof.

A filler is admixed into the unvulcanized rubber material. For this purpose, the filler is added to the unvulcanized rubber material in a mixer 1, which thoroughly mixes the components until the filler has been homogenously mixed into the unvulcanized rubber material. Particles of glass, porcelain, earthenware and/or stoneware are used as the filler. Furthermore, additional fillers can be added to the unvulcanized rubber material. The thorough mixing can also be achieved additionally or alternatively by calandering the unvulcanized rubber material. The particles are recycled substances and can be obtained by grinding up products consisting of fired porcelain, fired earthenware or fired stoneware, or else by grinding up glass. For instance, rejects consisting of porcelain, earthenware or stoneware can be ground up to form the particles which are then added to the unvulcanized rubber material as the ground-up product. Of course, it is also possible to use products that are collected after they have completed their life cycle such as, for instance, old glass as well as old porcelain, earthenware or stoneware. The d₅₀ value of a grain size of these particles is preferably between 1 μm and 200 μm, especially between 1 μm and 20 μm.

The particles of glass, porcelain, earthenware and/or stoneware are admixed in a proportion of 10% by weight to 80% by weight, relative to the two-dimensional rubber covering, so that the finished rubber covering contains between 10% by weight and 80% by weight of the particles.

The unvulcanized rubber material 2 with the admixed particles is characterized by its excellent processing properties. This is already evident from the viscosity of the unvulcanized rubber material containing the particles. Here, a Mooney viscosity of less than 160 ML (1+4) 100° C. is obtained according to DIN standard 53523, preferably less than 145 ML (1+4) 100° C. or less than 120 ML (1+4) 100° C. These properties allow an effective thorough mixing, whereby at the same time, the formation of bubbles is avoided or reduced.

In a subsequent step, the rubber material is rendered into a two-dimensional state in order to create a corresponding covering. This conversion into the two-dimensional state can be done, for example, by calandering the rubber material using the calanders 3 and 4. In the embodiment shown, two calanders 3 and 4 are provided, which each have two calander rollers 5, 6 or 5′, 6′ that rotate in opposite directions. In this process, the rubber material is brought to the desired thickness in that it is conveyed through the gap formed between the calander rollers.

Finally, in another step, the rubber material, which is in the two-dimensional state, is then crosslinked. The crosslinking can especially be carried out under exposure to heat and pressure in the vulcanization unit 7. This yields a two-dimensional covering 8 made of vulcanized rubber material. The covering can either be produced already in the desired thickness, or else the produced covering is split after the crosslinking. The covering can especially be used on floors as a floor covering.

If a rubber material crosslinked with sulfur is used, the glass particles function as crosslinking accelerators. For this reason, the use of other crosslinking accelerators can be considerably reduced.

Table 1 shows as examples the composition of three rubber mixtures, which are designated as Mixture 1, Mixture 2, and Mixture 3. The figures stand for the parts by weight of each of the constituents of the mixture.

TABLE 1
Composition

| | Mixture 1 | Mixture 2 | Mixture 3 |
|---|---|---|---|
| Precipitated silicic acid | 30 | 30 | 30 |
| Kaolin | — | 160 | 160 |
| Glass powder | 160 | — | — |
| Recycled rubber | — | 100 | — |
| Expanded recycled rubber | — | — | 33.30 |
| SBR with 23% styrene content | 75 | 75 | 75 |
| SBR with 70% styrene content | 10 | 10 | 10 |
| Zinc oxide | 3.740 | 3.740 | 3.740 |
| Polyethylene glycol | 1.00 | 1.00 | 1.00 |
| Stearic acid | 1.00 | 1.00 | 1.00 |
| Paraffin | 1.00 | 1.00 | 1.00 |
| Sulfur | 2.50 | 2.50 | 2.50 |
| Cyclohexyl benzothiazyl sulfenamide | 2.00 | 2.00 | 2.00 |
| Tetramethyl thiuram disulfide | 0.00 | 1.30 | 1.30 |

Mixture 1 contains 160 parts by weight of glass powder, whereby 85 parts by weight of SBR with a 23% or 70% styrene content are provided. Mixture 2 does not contain any glass powder, but it contains 160 parts by weight of kaolin and 100 parts by weight of recycled rubber as the filler. Mixture 3 is a mixture with 160 parts by weight of kaolin and 33.30 parts by weight of expanded recycled rubber as the filler.

Table 2 shows the resultant Mooney values of Mixtures 1, 2 and 3 before the crosslinking. The Mooney viscosities have been determined according to DIN 53523. Part 3 of this DIN standard deals primarily with the determination of viscosity according to Mooney while Part 4 deals with the determination of the scorch behavior according to Mooney.

TABLE 2
Characteristic values before the crosslinking

| | Mixture 1 | Mixture 2 | Mixture 3 |
|---|---|---|---|
| Mooney viscosity | 144 | >170 | 168 |
| ML (1 + 4) 100° C. | | | |
| Mooney scorch time | 4.22 | 2.70 | 3.91 |
| t₅ in minutes at 140° C. | | | |
| Mooney viscosity minimum | 57 | 85 | 59 |
| at 140° C. | | | |

Table 2 shows that Mixture 1 exhibits good processing properties. The Mooney viscosity at 100° C. is below 160 Mooney units, even below 150 Mooney units. In the case of Mixture 2, however, the Mooney viscosity is so high that it can no longer be measured. This mixture can no longer be processed. With Mixture 3 as well, the Mooney viscosity at 100° C. is very high, which makes it difficult or impossible to process. The scorch times are sufficiently long, so that the materials can be processed before the vulcanization hinders further processing.

Table 3 shows the mechanical characteristic values of Mixtures 1, 2 and 3 after the crosslinking.

TABLE 3
Mechanical characteristic values after the crosslinking

| | Mixture 1 | Mixture 2 | Mixture 3 |
|---|---|---|---|
| Hardness [Shore A] | 94 | 93 | 95 |
| Rebound resilience | 15 | 18 | 23 |
| Tension value 20% [MPa] | 3.9 | 5.2 | 5.7 |
| Tensile strength [MPa] | 7.4 | 8.3 | 5.8 |
| Elongation at break [%] | 85 | 132 | 32 |
| Tear propagation resistance [N/mm] | 4.8 | | 4.9 |

Table 3 shows that Mixture 1 has good mechanical characteristic values, so that the covering lends itself very well for a sturdy floor covering, also for heavy wear.

Table 4 shows as examples the composition of additional Mixtures 4 through 8, each with different percentages of glass powder, porcelain powder and/or kaolin as the filler.

TABLE 4
Composition of additional mixtures

| | Mixture 4 | Mixture 5 | Mixture 6 | Mixture 7 | Mixture 8 |
|---|---|---|---|---|---|
| Precipitated | 15.40 | 15.40 | 15.40 | 15.40 | 15.40 |
| silicic acid | | | | | |
| Kaolin | 154.875 | — | — | 77.44 | — |
| Glass | — | 154.875 | 154.875 | — | 77.44 |
| powder | | | | | |
| Porcelain | — | — | — | 77.44 | 77.44 |
| powder | | | | | |
| SBR with | 41 | 41 | 41 | 41 | 41 |
| 23% styrene | | | | | |
| content | | | | | |
| SBR with | 18 | 18 | 18 | 18 | 18 |
| 70% styrene | | | | | |
| content | | | | | |
| Zinc oxide | 5.120 | 5.120 | 5.120 | 5.120 | 5.120 |
| Polyethylene | 5.00 | 5.00 | 5.00 | 5.00 | 5.00 |
| glycol | | | | | |
| Stearic acid | 1.55 | 1.55 | 1.55 | 1.55 | 1.55 |
| Paraffin | 0.50 | 0.50 | 0.50 | 0.50 | 0.50 |
| Sulfur | 3.00 | 3.00 | 3.00 | 3.00 | 3.00 |
| Cyclohexyl | 1.00 | 1.00 | 1.00 | 1.00 | 1.00 |
| benzothiazyl | | | | | |
| sulfenamide | | | | | |
| Tetramethyl | 1.00 | 1.00 | 0.00 | 1.00 | 1.00 |
| thiuram | | | | | |
| disulfide | | | | | |

Table 5 shows the Mooney values of Mixtures 4 through 8. The good processing properties of the mixtures with particles of glass or porcelain can be clearly seen here.

TABLE 5
Characteristic values before the crosslinking of Mixtures 4 through 8

| | Mixture 4 | Mixture 5 | Mixture 6 | Mixture 7 | Mixture 8 |
|---|---|---|---|---|---|
| Mooney | 89 | 108 | 86 | 71 | 71 |
| viscosity | | | | | |
| ML (1 + 4) | | | | | |
| 100° C. | | | | | |
| Mooney | 3.95 | 0.75 | 7 | 3.34 | 0.86 |
| scorch | | | | | |
| time t₅ | | | | | |
| in minutes | | | | | |
| at 140° C. | | | | | |
| Mooney | 31 | 38 | 11 | 26 | 33 |
| viscosity | | | | | |
| minimum | | | | | |
| at 140° C. | | | | | |

Table 6 shows the vulcanization properties of Mixtures 4 through 8. Mixture 5 containing glass powder shows that here, the vulcanization times are considerably accelerated in comparison to Mixture 4. Even when the vulcanization accelerator (tetramethyl thiuram disulfide) is left out, as is the case with Mixture 6, which is otherwise identical to Mixture 5, it is still possible to attain very good vulcanization properties. A comparable acceleration of the vulcanization does not occur with Mixture 7, which does not contain any glass powder. Mixture 8, which contains particles of glass and porcelain, once again confirms the accelerating effect of the glass particles, even when they are provided in combination with porcelain particles. In this manner, thanks to the content of glass particles, the vulcanization can be accelerated or else the same vulcanization times can be achieved with smaller amounts of vulcanization accelerators.

TABLE 6
Vulcameter values (170° C., 6 minutes) of Mixtures 4 through 8

| | Mixture 4 | Mixture 5 | Mixture 6 | Mixture 7 | Mixture 8 |
|---|---|---|---|---|---|
| ti [s] | 55 | 19 | 50 | 52 | 24 |
| t20 [s] | 61 | 23 | 58 | 57 | 28 |
| t90 [s] | 189 | 61 | 182 | 86 | 121 |
| t20/t90 [s] | 0.32 | 0.38 | 0.32 | 0.66 | 0.23 |
| D min | 0.27 | 0.31 | 0.33 | 0.23 | 0.26 |
| D max | 2.57 | 1.93 | 2.05 | 2.24 | 2.08 |
| delta D | 2.30 | 1.62 | 1.72 | 2.01 | 1.82 |

Table 7 confirms the good mechanical properties of the coverings containing particles of glass or porcelain.

TABLE 7
Mechanical characteristic values after the crosslinking of Mixtures 4
through 8

| | Mixture 4 | Mixture 5 | Mixture 6 | Mixture 7 | Mixture 8 |
|---|---|---|---|---|---|
| Hardness | 96 | 91 | 93 | 94 | 92 |
| [Shore A] | | | | | |
| Rebound | 25 | 29 | 28 | 28 | 26 |
| resilience | | | | | |
| Elongation | 6.3 | 3.1 | 3.5 | 4.9 | 3.2 |
| force 20% | | | | | |
| [MPa] | | | | | |
| Tensile | 7.8 | 4.7 | 4.5 | 5.5 | 4.1 |
| strength | | | | | |
| [MPa] | | | | | |
| Elongation at | 48 | 198 | 202 | 64 | 135 |
| break [%] | | | | | |
| Tear | 4.4 | 3.3 | 3.8 | 3.9 | 3.1 |
| propagation | | | | | |
| resistance | | | | | |
| [N/mm] | | | | | |

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-13. (canceled)

14. A method for producing a two-dimensional rubber covering, in particular a floor covering, comprising the steps:
providing an unvulcanized rubber material,
mixing a filler into the unvulcanized rubber material,
rendering the rubber material into a two-dimensional state, and
crosslinking the rubber material in the two-dimensional state,
wherein the filler contains particles of at least one of glass, porcelain, earthenware and stoneware.

15. The method according to claim 14, wherein the Mooney viscosity of the unvulcanized rubber material is less than 160 ML (1+4) 100° C. as measured according to DIN standard 53523 after the filler has been admixed into it.

16. The method according to claim 15, wherein the Mooney viscosity of the unvulcanized rubber material is less than 145 ML (1+4) 100° C. as measured according to DIN standard 53523 after the filler has been admixed into it.

17. The method according to claim 16, wherein the Mooney viscosity of the unvulcanized rubber material is less than 120 ML (1+4) 100° C. as measured according to DIN standard 53523 after the filler has been admixed into it.

18. The method according claim 14, wherein the particles of at least one of glass, porcelain, earthenware and stoneware are recycled materials.

19. The method according to claim 14, wherein the particles of at least one of glass, porcelain, earthenware and/or stoneware are mixed in as a ground-up product.

20. The method according to claim 19, wherein the d₅₀ value of a grain size of the particles is between 1 μm and 200 μm.

21. The method according to claim 19, wherein the d₅₀ value of a grain size of the particles is between 1 μm and 20 μm.

22. The method according to claim 14, wherein the particles of at least one of glass, porcelain, earthenware and stoneware are admixed in a proportion of 10% by weight to 80% by weight, relative to the two-dimensional rubber covering.

23. The method according to claim 14, wherein the rubber covering is crosslinked with at least one of peroxides, sulfur and additives.

24. The method according to claim 23, wherein crosslinking with sulfur is accelerated by using crosslinking accelerators or combinations thereof.

25. The method according to claim 24, wherein, the accelerators contain substances belonging to one or more of the classes of dithiocarbamates, metal salts of dithiocarbamates, thiurams, mercapto accelerators, sulfenamides and guanidines.

26. The method according to claim 14, wherein the particles have basic properties.

27. The method according to claim 14, wherein the crosslinking with sulfur is accelerated by using particles of glass.

28. The method according to claim 14, wherein the rubber material contains at least one of SBR (styrene butadiene rubber), NBR (nitrile butadiene rubber), HNBR (hydrogenated nitrile butadiene rubber), EPDM (ethylene propylene diene rubber), EPM (ethylene propylene rubber), EVA (ethylene vinyl acetate), CSM (chlorosulfonyl polyethylene rubber), CR (chloroprene rubber), VSI (silicone rubber) and AEM (ethylene acrylate rubber).

29. A two-dimensional rubber covering into which particles of at least one of glass, porcelain, earthenware and stoneware have been admixed as the filler.
